(19) United States
(12) Patent Application Publication
(10) Pub. No.: US 2008/0207844 A1
(43) Pub. Date: Aug. 28, 2008

(54) Exterior member for electronic devices and electronic device equipped with externally connecting terminal cap comprising the same

(76) Inventors: Shinichi Kanazawa, Osaka (JP); Yoshito Sakamoto, Osaka (JP); Satoshi Yamazaki, Osaka (JP); Shun Kayama, Tokyo (JP); Yukiko Shimizu, Tokyo (JP)

Correspondence Address: MCDERMOTT WILL & EMERY LLP, 600 13TH STREET, N.W., WASHINGTON, DC, 20005-3096, US

(21) Appl. No.: 12/068,648

(22) Filed: Feb. 8, 2008

(30) Foreign Application Priority Data
Feb. 9, 2007 (JP) P. 2007-030935

(51) Int. Cl. C08F 283/01; H05B 6/00

(52) U.S. Cl. 525/451; 264/488; 525/418

(57) ABSTRACT

A molded article obtained by blending a poly-functional monomer in a biodegradable polyester, kneading the blend, and molding the kneaded material into a predetermined shape is irradiated with ionizing radiation at an irradiation dose of 50 to 200 kGy to crosslink the biodegradable polyester to a gel fraction of 50 to 90%, where the flexural modulus is from 100 to 400 MPa, and the Young's modulus is from 60 to 240 MPa.

### BACKGROUND OF THE INVENTION

The present invention relates to an exterior member for electronic devices. More specifically, the present invention relates to an exterior member for electronic devices, which is suitably used as an externally connecting terminal cap or the like of a cellular phone and enables reduction in the waste volume at the disposal after use.

In the housing of a portable device such as cellular phone and portable CD player or video camera, an opening for an externally connecting terminal is provided, and a cap (or cover) integrally molded from rubber or resin is fixed to the opening. For example, JP-A-2002-111240 (the term “JP-A” as used herein means an “unexamined published Japanese patent application”) (Patent Document 1) discloses a technique of forming the cap from a resin such as ABS (acrylonitrile butadiene styrene), PC/ABS (poly-carbonate/acrylonitrile butadiene styrene), PA (polyamide) and PC (polycarbonate).

### [Patent Document 1] JP-A-2002-111240

When the cap is made of a resin as described above, a problem arises at the combustion disposal treatment after use. More specifically, there are generated as social problems, for example, global warming due to heat or exhaust gas generated at the combustion, adverse effect of toxic substances in the combustion gas or combustion residue on food or health, and securing of a waste treatment or landfill site.

To solve these problems, a biodegradable polymer such as typically starch and polylactic acid is a material conventionally taken notice of as a material capable of solving the problems in the waste treatment of petroleum-based synthetic polymers. The biodegradable polymer does not adversely affect the global environment including ecosystems as compared with petroleum-based synthetic polymers, for example, the quantity of heat accompanying combustion is small and the cycle of degradation and resynthesis is maintained in a natural environment. Above all, an aliphatic polyester resin having properties comparable to the petroleum-based synthetic polymer in terms of strength and processability is a material that is recently gaining a lot of attention.

In particular, a polylactic acid is produced from plant-sourced starch and is becoming very inexpensive as compared with other biodegradable polymers by virtue of recent mass production and concomitant cost reduction and therefore, many studies are being made on its application at present.

Also from the characteristic aspect, the polylactic acid is a most promising biodegradable resin as an alternative material of the petroleum-based synthetic polymer because of its processability and strength comparable to the general-purpose petroleum-based synthetic polymer. Furthermore, its application to various uses is expected, for example, as an alternative of acrylic resin in view of comparable transparency or as an alternative of an ABS resin such as casing of an electronic device in view of high Young's modulus and good shape retentivity.

However, the polylactic acid has a glass transition point at a relatively low temperature in the vicinity of 60° C. and is disadvantageous in that the Young's modulus seriously decreases around this temperature to such an extent as abruptly changing a so-called glass sheet into a vinyl-made tablecloth and the shape can be hardly maintained.

In this way, the molded article made of a biodegradable resin typified by polylactic acid is an effective material as regards the waste treatment but has a problem in view of heat resistance and, for example, when a portable device is left standing in an automobile where the cabin temperature elevates to 60° C. or more at high temperatures in summer season, deformation may occur.

On the other hand, from the standpoint of flexibility, the glass transition temperature is in the vicinity of 60° C. as described above and there is a problem that the polylactic acid lacks flexibility at ordinary temperature which subsides below the glass transition temperature and a molded article requiring flexibility may be readily broken depending on the form of usage.

### SUMMARY OF THE INVENTION

The present invention is made in consideration of these problems and an object of the present invention is to provide an exterior member for electronic devices, such as externally connecting terminal cap of a cellular phone, comprising a biodegradable material ensuring that a molding material formed from the biodegradable material is enhanced in the heat resistance and strength and can maintain the shape even in a high-temperature environment, and also having flexibility of less causing breakage at ordinary temperature.

As a result of continuous and intensive studies on these problems, the present inventors have found that the above-described object can be attained by mixing a polyfunctional monomer with a biodegradable polymer and crosslinking the molecules with each other, for example, by the irradiation of radiation to a certain condition or more, thereby obtaining a material having predetermined flexural modulus and Young's modulus.

Based on this finding, according to a first aspect of the invention, there is provided an exterior member for electronic devices, including:

a biodegradable polyester, and

a polyfunctional monomer mixed in the biodegradable polyester, wherein

the biodegradable polyester has a crosslinked structure with a gel fraction (dry weight of gel portion/initial dry weight) of 50 to 90%,

the flexural modulus is from 100 to 400 MPa, and

the Young's modulus is from 60 to 240 MPa.

According to a second aspect of the invention, there is provided the exterior member for electronic devices as in the first aspect of the invention, wherein

the yield strength is 8.5 MPa or more.

According to a third aspect of the invention, there is provided the exterior member for electronic devices as in the first or second aspect of the invention, wherein

a natural-origin or petroleum-origin polymer having a glass transition temperature not more than ordinary temperature is used as the biodegradable polyester.

According to a forth aspect of the invention, there is provided the exterior member for electronic devices as in the third aspect, wherein

50 parts by mass or more of one or more members selected from the group including polybutylene adipate terephthalate, polybutylene succinate adipate and polybutylene succinate lactide are contained in 100 parts by mass of the biodegradable polyester.

According to a fifth aspect of the invention, there is provided the exterior member for electronic devices as in any one of the first to forth aspects, wherein

the polyfunctional monomer comprises an acrylic or methacrylic monomer and the polyfunctional monomer is blended in an amount of 2 to 15 parts by mass per 100 parts by mass of the biodegradable polyester.

According to a sixth aspect of the invention, there is provided an electronic device equipped with an externally connecting terminal cap comprising the exterior member as in any one of the first to fifth aspects.

Further, according to a seventh aspect of the invention, there is provided a method for producing the exterior member for electronic devices as in the first to fifth aspects, which is a production method of an exterior member such as externally connecting terminal cap of a cellular phone,

the method including the steps of:

blending a polyfunctional monomer in a biodegradable polyester,

kneading the blend,

molding the kneaded material into a predetermined shape,

irradiating the molded article with ionizing radiation at an irradiation dose of 50 to 200 kGy to crosslink the biodegradable polyester to a gel fraction of 50 to 90%.

In the first invention, the flexural modulus is specified to be from 100 to 400 MPa and the Young's modulus is specified to be from 60 to 240 MPa, because the physical properties in these ranges are particularly suitable for use as a cap or cover material for externally connecting terminals. More specifically, if the flexural modulus is less than 100 MPa, practically sufficient strength cannot be maintained due to excessive flexibility, whereas if it exceeds 400 MPa, the cap becomes hard and may not be successfully fit onto the opening of an electronic device. The flexural modulus is preferably from 130 to 300 MPa.

The Young's modulus is specified to be from 60 to 240 MPa because of the same reasons. The Young's modulus is preferably from 80 to 200 MPa.

The flexural modulus is measured according to JIS K7171, ISO 178 and ASTM D790, and the Young's modulus is measured according to JIS K7127, ISO 527 and ASTM D882.

The flexible exterior member as an objective of the present invention is required to have a yield strength nearly equal to the limit value at which the shape can be elastically recovered against a load such as bending or elongation, and it is at the same time important that the yield strength is high. Specifically, the exterior member of the present invention preferably has a yield strength of 8.5 MPa or more, more preferably 9.0 MPa or more.

Examples of the biodegradable polyester for use in the present invention include polylactones typified by ε-polycaprolactone and δ-polybutyrolactone; copolymers of a dicarboxylic acid typified by succinic acid, adipic acid, sebacic acid, glutaric acid, decanedicarboxylic acid, terephthalic acid and isophthalic acid, and a polyhydric alcohol typified by ethanediol, propanediol, butanediol, octanediol and dodecanediol, such as polyethylene succinate, polybutylene succinate, polybutylene adipate and polybutylene adipate terephthalate; copolymers obtained by further adding a polylactic acid to the copolymers above, such as polybutylene succinate lactide and polybutylene succinate adipate lactide; polyhydroxycarboxylic acids typified by polyglycolic acid, polyhydroxybutyric acid, polyhydroxyvaleric acid and polyhydroxycaproic acid; a polylactic acid comprising L-lactic acid; a polylactic acid comprising D-lactic acid; and a polylactic acid obtained by polymerizing a mixture of L-lactic acid and D-lactic acid. A mixture of two or more of these homopolymers or copolymers may also be used.

Particularly, many biodegradable polyesters described above such as polybutylene succinate, except for a polylactic acid alone, have a glass transition temperature not more than ordinary temperature and can be suitably used in the present invention which purports to hold flexibility at ordinary temperature. When such a polymer is used as a main component and contained in an amount of 50 parts by mass or more in 100 parts by mass of the biodegradable polyester, the polymer having a glass transition temperature not more than ordinary temperature can govern the strength of the entire polymer and therefore, even a polymer or the like comprising a polylactic acid alone having a glass transition temperature of 50 to 60° C. that is higher than the ordinary temperature may also be partially added and used. Incidentally, the “ordinary temperature” as used in the context of the present invention indicates a room temperature when heating, cooling or the like is not applied.

The polybutylene succinate, polybutylene succinate lactide, polybutylene succinate adipate lactide and the like described above may be either a petroleum-origin polymer or a partially or entirely natural-origin polymer.

In order to obtain a flexible exterior member having a flexural modulus of 100 to 400 MPa and a Young's modulus of 60 to 240 MPa, a biodegradable polyester selected from polybutylene adipate terephthalate, polybutylene succinate adipate and polybutylene succinate lactide is preferably contained alone or as a mixture of two or more thereof in an amount of 50 parts by mass or more, more preferably 80 parts by mass or more, in 100 parts by mass of the biodegradable polyester.

The polyfunctional monomer is not particularly limited as long as it is a monomer capable of being crosslinked by the irradiation of ionizing radiation, such as triallyl isocyanurate, but an acrylic or methacrylic polyfunctional monomer having two or more double bonds within one molecule is suitably used.

Examples of the monomer of this type include 1,6-hexanediol di(meth)acrylate, 1,4-butanediol di(meth)-acrylate, trimethylolpropane tri(meth)acrylate, ethylene oxide-modified trimethylolpropane tri(meth)acrylate, propylene oxide-modified trimethylolpropane tri(meth)-acrylate, ethylene oxide-modified bisphenol A di(meth)acrylate, diethylene glycol di(meth)acrylate, dipentaerythritol hexaacrylate, dipentaerythritol monohydroxypentaacrylate, caprolactone-modified dipentaerythritol hexaacrylate, pentaerythritol tri(meth)acrylate, pentaerythritol tetra(meth)acrylate, polyethylene glycol di(meth)acrylate, tris(acryloxyethyl) isocyanurate and tris(methacryloxyethyl) isocyanurate.

The polyfunctional monomer for use in the present invention is preferably blended in an amount of 2 to 15 parts by mass per 100 parts by mass of the biodegradable polyester.

The blending amount is 2 parts by mass or more because if it is less than 2 parts by mass, the polyfunctional monomer cannot fully exert the effect of crosslinking the biodegradable polyester and the strength at a high temperature is decreased, failing in maintaining the shape at worst. On the other hand, if the blending amount exceeds 15 parts by mass, the entire amount of the polyfunctional monomer is difficult to mix uniformly in the biodegradable polyester and a prominent difference is substantially not created in the crosslinking effect.

The blending amount is preferably 3 parts by mass or more for unfailingly bringing out the shape-maintaining effect at high temperatures and preferably 10 parts by mass or less for enhancing the biodegradability by increasing the biodegradable polyester content.

In the composition constituting the molded article of the biodegradable polyester, in addition to the above-described biodegradable polyester and polyfunctional monomer, other components may be further blended as long as these are not contracting the purpose of the present invention.

For example, a biodegradable material other than the biodegradable polyester may be blended. The biodegradable material other than the biodegradable polyester includes a synthetic biodegradable resin such as polyvinyl alcohol, and a natural biodegradable resin such as natural linear polyester (e.g., polyhydroxybutyrate valerate).

Also, a synthetic polymer having biodegradability and/or a natural polymer may be mixed within the range not impairing the melting property. The synthetic polymer having biodegradability includes a cellulose ester such as cellulose acetate, cellulose butyrate, cellulose propionate, cellulose nitrate, cellulose sulfate, cellulose acetate butyrate and cellulose nitrate acetate, and a polypeptide such as polyglutamic acid, polyaspartic acid and polyleucine. The natural polymer includes, for example, starch including raw starch such as corn starch, wheat starch and rice starch, and processed starch such as acetate-esterified starch, methyl etherified starch and amylose.

In addition to the biodegradable resin, the biodegradable polyester composition may contain a curable oligomer; various additives such as stabilizer, flame retardant, hydrolysis inhibitor, antistatic agent, antifungal, nucleating agent for accelerating polylactic acid crystallization, and tackifier; an inorganic/organic packing material such as glass fiber, glass bead, metal powder, talc, mica and silica; a filler or a filler surface-treated with silane, stearic acid or the like; and a colorant such as dye and pigment.

Above all, it is particularly preferred to blend an inorganic filler for reinforcement. At the same time, in order to obtain a predeterminedly colored exterior member for electronic devices, a dye or a pigment is preferably blended. Incidentally, a paint may be coated on the outer surface of the crosslinked molded product without blending a dye or a pigment in the composition.

The composition containing the above-described biodegradable polyester and polyfunctional monomer and, if desired, other components is molded into a desired shape.

The molding method is not particularly limited and a known method may be used. For example, a known molding machine such as extrusion molding machine, compression molding machine, vacuum molding machine, blow molding machine, T-die molding machine, injection molding machine and inflation molding machine may be used.

After molding the biodegradable polyester composition into a predetermined shape, the biodegradable polyester composition is crosslinked. The crosslinking method is not particularly limited and although a known method may be used, it is most preferred to effect the crosslinking by irradiating ionizing radiation.

Examples of the ionizing radiation which can be used include a γ-ray, an X-ray, a β-ray and an α-ray. In the industrial production, γ-ray irradiation using cobalt-60 or electron beam irradiation by an electron beam accelerator is preferred.

The irradiation of ionizing radiation is preferably performed under an inert atmosphere or vacuum by expelling air. Because, if the active species produced upon irradiation with ionizing radiation is coupled with oxygen in air and deactivated, the crosslinking efficiency decreases.

The irradiation dose of ionizing radiation is preferably from 50 to 200 kGy.

Even when the irradiation dose of ionizing radiation is from 1 to 10 kGy, the biodegradable polyester is crosslinked depending on the amount of the polyfunctional monomer, but in order to crosslink the molecules in almost 100% of the biodegradable polyester, the irradiation dose of ionizing radiation is preferably 50 kGy or more. Furthermore, for completely performing the crosslinking and integration, the irradiation dose of ionizing radiation is more preferably 80 kGy or more.

On the other hand, the irradiation dose of ionizing radiation is 200 kGy or less, because the biodegradable polyester as a resin alone has a property of collapsing by radiation and if the irradiation dose of ionizing radiation exceeds 200 kGy, degradation but not crosslinking proceeds. The upper limit of the irradiation dose of ionizing radiation is preferably 150 kGy, more preferably 100 kGy.

The irradiation dose is more preferably from 60 to 150 kGy, still more preferably from 80 to 120 kGy.

Instead of irradiating ionizing radiation to effect crosslinking, a biodegradable crosslinked body can be produced also by mixing a polyfunctional monomer and a chemical initiator with a biodegradable polyester, molding the mixture into a desired shape and heating the molded article up to a temperature at which the chemical initiator is thermally decomposed.

As for the polyfunctional monomer, the same substances as in the above-described embodiment may be used.

The chemical initiator may be any substance as long as it is a catalyst initiating the polymerization of the monomer, including a peroxide catalyst capable of producing a peroxide radical by thermal decomposition, such as dicumyl peroxide, propionitrile peroxide, benzoyl peroxide, di-tert-butyl peroxide, diacyl peroxide, pelargonyl peroxide, myristoyl peroxide, tert-butyl perbenzoate and 2,2′-azobisisobutyronitrile.

The temperature condition for the crosslinking may be appropriately selected according to the kind of the chemical initiator. The crosslinking is preferably performed under an inert atmosphere or vacuum by expelling air, similarly to the case of irradiating radiation.

In the biodegradable oily polyester molding material produced by the above-described method, the gel fraction (dry weight of gel portion/initial dry weight) is made to be from 50 to 90% by the crosslinking.

In the present invention, the degree of crosslinking is specified by the gel fraction.

The gel fraction is obtained by wrapping a predetermined amount of a film subjected to irradiation crosslinking or chemical crosslinking with a 200-mesh wire gauze, boiling it in an N,N-dimethylformamide (DMF) solution for 48 hours, removing the dissolved sol portion, drying the gel portion remaining in the wire gauze at 50° C. for 24 hours, and determining its weight. The gel fraction is calculated according to the following formula:

Gel fraction (%)=(dry weight of gel portion)/(initial dry weight)×100

In the crosslinked polymer above, when the glass fraction is set to be 50% or more, innumerable three-dimensional network structures are produced in the polymer, and heat resistance not allowing deformation in a high-temperature environment can be imparted.

If the gel fraction exceeds 90%, the polymer becomes too hard and the flexural strength disadvantageously decreases due to lack in flexibility. The gel fraction is preferably from 60 to 90%.

The biodegradable polyester composition rendered to have a gel fraction of 50 to 80% by the crosslinking can give a molded article having physical properties of the melting point being from 150 to 200° C., the flexural modulus being from 100 to 400 MPa, the Young's modulus being from 60 to 240 MPa, and the Young's modulus retention at high temperatures being 70% or more.

The crosslinked body comprising a biodegradable polyester composition, which works out to the exterior member for electronic devices of the present invention, can enhance the thermal deformation temperature of the biodegradable polyester by the effect of crosslinking. That is, by virtue of the crosslinked network formed in the biodegradable polyester by crosslinking, the shape can be unfailingly maintained even at high temperatures.

Also, the external member of the present invention is molded from a biodegradable resin and therefore, has very little effect on ecosystems in nature, so that various problems possessed by conventional plastics in regard to waste treatment can be overcome.

Particularly, in the case where the external member for electronic devices of the present invention is a freely removable cap or cover material, for example, a cap fit onto an opening for external terminal connection of a cellular phone, flexibility is required so as to less cause breakage when the cap is put on and take off. In such a case, when a polymer having a glass transition temperature not more than ordinary temperature is used as the biodegradable polyester, this is advantageous in that flexibility can be maintained at ordinary temperature and in turn, breakage can hardly occur.

### BRIEF DESCRIPTION OF THE DRAWINGS

FIGS. 1(A), 1(B) and 1(C) are views showing a cellular phone quipped with a cap in the embodiment of the present invention.

FIG. 2 is a view showing the process of irradiating electron beams.

### DETAILED DESCRIPTION OF THE PREFERRED EMBODIMENTS

The embodiment of the present invention is described below.

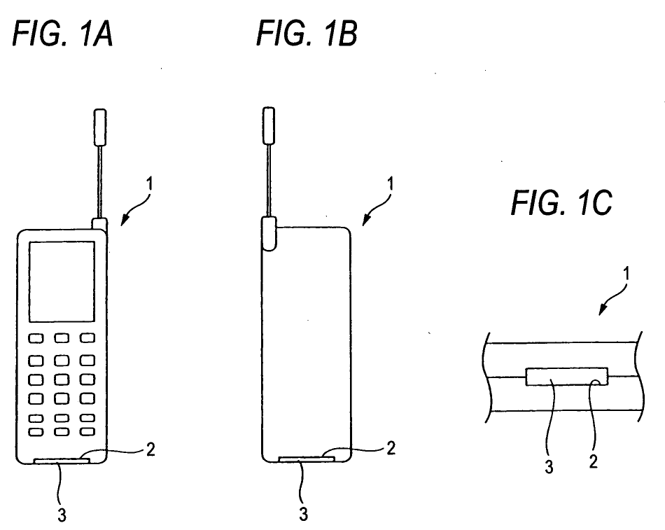

The external member for electronic devices of the present invention is used as a cap 3 covering an opening 2 provided in the portion for the connection to an external terminal of a cellular phone 1 shown in FIG. 1.

The cap 3 is molded from a heat-resistant bio-degradable polyester composition and produced by the following procedure.

A biodegradable polyester is prepared using from 60 to 100 parts by mass of polybutylene adipate terephthalate, from 0 to 40 parts by mass of polybutylene succinate adipate or polybutylene succinate lactide, and from 6 to 13 parts by mass of polylactic acid, and a pellet of the obtained biodegradable polyester is softened by heating, or the biodegradable polyester is degraded in a solvent where the biodegradable polyester can be dissolved.

Subsequently, the biodegradable polyester is softened by heating, and a polyfunctional monomer is added thereto. Trimethylolpropane trimethacrylate (TMPT) is added as the polyfunctional monomer. The polyfunctional monomer is added in an amount of 5 to 10 parts by mass per 100 parts by mass of the biodegradable polyester. After the addition, the system is mixed with stirring to equalize the polyfunctional monomer.

Thereafter, the solvent may be further removed by drying.

The obtained composition is again softened by heating or the like and molded into a cap 3 shape.

The molding after adjusting the composition may be performed, for example, in succession while keeping the state of being dissolved in the solvent, or may be performed after once cooling the composition or removing the solvent by drying.

The obtained biodegradable polyester molded article is then irradiated with ionizing radiation to crosslink the biodegradable polyester, whereby a heat-resistant bio-degradable polyester is obtained. As for the ionizing radiation, irradiation of electron beams by an electron beam accelerator is preferred, and the irradiation dose of radiation is appropriately selected from the range of 50 to 150 kGy according to the blending amount of polyfunctional monomer, or the like.

Particularly, the irradiation dose is selected such that the gel fraction of the heat-resistant biodegradable polyester obtained after irradiation of ionizing radiation becomes 50% or more.

### EXAMPLES

The present invention is described in greater detail below by referring to Examples of the present invention and Comparative Examples, but the present invention is not limited to these Examples.

### Example 1

A biodegradable polyester is prepared using a pellet-like polybutylene adipate terephthalate, “ECOFLEX (trade name)”, produced by BASF and a polylactic acid, “LACEA H-280 (trade name)”, produced by Mitsui Chemicals, Inc. Here, LACEA H-280 is used in a ratio of 13 parts by mass to 100 parts by mass of ECOFLEX.

The prepared biodegradable polyester is previously melted and kneaded using an extruder (Model PCM30, manufactured by Ikegai Iron Works, Ltd.) at a cylinder temperature of 150° C. and thereto, TMPT which is a kind of polyfunctional monomer is added little by little to finally occupy 5 parts by weight per 100 parts by weight of ECOFLEX, whereby a mixture is prepared.

The prepared mixture is cooled and formed into pellets by a pelletizer to obtain a pellet-like kneaded material of biodegradable polyester and polyfunctional monomer. This kneaded material is hot-pressed into a sheet form at 150° C. and rapidly cooled by water cooling to produce a sheet.

The produced sheet is irradiated with electron beams at 60 kGy by using an electron beam accelerator (accelerating voltage: 10 MeV, current: 12 mA) in an inert atmosphere from which air is removed, whereby a heat-resistant biodegradable polyester is obtained.

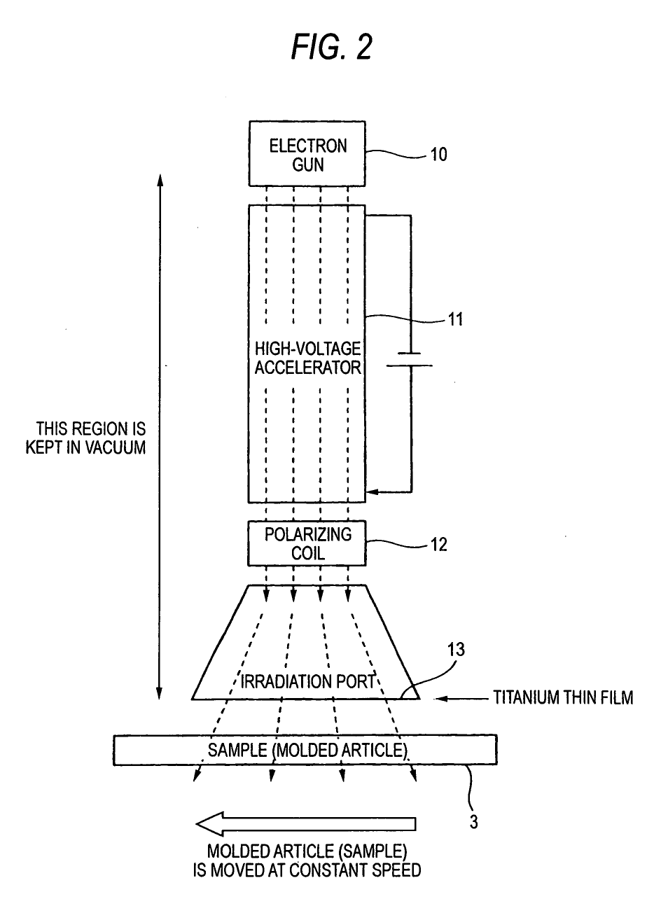

The electron beam irradiation above is specifically performed in such a manner that, as shown in FIG. 2, in a vacuum atmosphere, electrons emitted from an electron gun 10 are accelerated by a high voltage in a high-voltage accelerator 11 combined with a capacitor and after direction control by a polarizing coil 12, irradiated on a molded article 20 through a thin film 13 of titanium or the like.

The molded article 20 is moved at a constant speed by a conveyor 15 or the like, because irradiation thereon is stably performed at the same voltage and the same current.

### Example 2

This Example is performed in the same manner as in Example 1 except that the biodegradable polyester is prepared using a polybutylene adipate terephthalate, “ECOFLEX (trade name)”, produced by BASF, a polybutylene succinate adipate, “Bionolle #3001 (trade name)”, produced by Showa Highpolymer Co., Ltd. and a polylactic acid, “LACEA H-280 (trade name)”, produced by Mitsui Chemicals, Inc. by kneading 60 parts by weight of ECOFLEX, 40 parts by mass of Bionolle #3001, 6 parts by mass of LACEA H-280 and further 5 parts by mass of TMPT.

### Example 3

Example 3 is performed in the same manner as in Example 2 except that a polybutylene succinate lactide, “GsPLa AD82W (trade name)”, produced by Mitsubishi Chemical Corp. is used in place of Bionolle #3001.

### Comparative Example 1

Comparative Example 1 is performed in the same manner as in Example 1 except for not performing the electron beam irradiation.

### Comparative Example 2

Comparative Example 2 is performed in the same manner as in Example 3 except for not performing the electron beam irradiation.

### Evaluation of Examples and Comparative Examples

In Examples and Comparative Examples, the melt index (MI), gel fraction, flexural modulus, Young's modulus and yield strength are evaluated by the following methods.

### (MI (Melt Index))

The melt index is measured by the method in accordance with JIS K7210, ISO 1130 and ASTM D1238.

### (Gel Fraction)

The samples of Examples and Comparative Examples each is, after exactly measuring the dry weight, wrapped with a 200-mesh stainless steel gauze and then boiled in an N,N-dimethylformamide (DMF) solution for 48 hours, and the sol portion dissolved in DMF is removed to obtain the remaining gel portion. Furthermore, DMF in the gel is removed by drying at 50° C. for 24 hours, and the dry weight of the gel portion is measured. Based on the obtained value, the gel fraction is calculated according to the following formula:

Gel fraction (%)=(dry weight of gel portion)/(initial dry weight)×100

This method is in accordance with JIS K7210 and ISO 527.

### (Flexural Modulus)

The flexural modulus is measured in accordance with JIS K7171, ISO 178 and ASTM D790.

### (Young's Modulus, Yield Strength)

These are measured in accordance with JIS K7127, ISO 527 and ASTM D882.

The evaluation results of MI, gel fraction (%), flexural modulus (MPa), Young's modulus (MPa) and yield strength (MPa) in Examples and Comparative Examples are shown in Table 1 below.

TABLE 1

| | | Example | Example | Example | Comparative | Comparative |
|---|---|---|---|---|---|---|
| | | 1 | 2 | 3 | Example 1 | Example 2 |
| Blending | ECOFLEX | 100 | 60 | 60 | 100 | 60 |
| | Bionolle #3001 | | 40 | | | |
| | GsPLa AD82W | | | 40 | | 40 |
| | LACEA H-280 | 13 | 6 | 6 | 13 | 6 |
| | TMPT | 5 | 5 | 5 | 5 | 5 |

| | | | | | |
|---|---|---|---|---|---|
| Irradiation dose (kGy) | 60 | 60 | 60 | 0 | 0 |
| MI | 1.8 | 1.2 | 0.9 | 0.9 | 0.9 |
| Gel fraction (%) | 79 | 86 | 84 | 0 | 0 |
| Flexural modulus (MPa) | 133 | 210 | 135 | 100 | 121 |
| Young's modulus (MPa) | 89 | 164 | 139 | 77 | 139 |
| Yield strength (MPa) | 9.0 | 12.0 | 12.0 | 7.3 | 8.0 |

As shown in Table 1, in Examples 1 to 3, the gel fraction is from 79 to 86% and the crosslinking could be confirmed. On the other hand, in Comparative Examples 1 to 2 where electron beam irradiation is not performed, the gel fraction is 0% and the crosslinking is not effected.

In Examples 1 to 3, the flexural elasticity is from 133 to 210 MPa and the Young's modulus is from 89 to 164 MPa. Thus, the sample is slightly hard with an increase in the flexural modulus and Young's modulus as compared with Comparative Examples 1 and 2 where electron beam irradiation is not performed, but this is within the range giving no difference to the touch by a human hand and the flexibility is sufficiently high.

Also, in Examples 1 to 3, the yield strength is 9.0 MPa or more and is excellent by from 30 to 40% as compared with Comparative Examples 1 and 2. In this way, the exterior members of Examples 1 to 3 are flexible, nevertheless, possessed high yield strength.

As seen from these results, the molded article mainly comprising the biodegradable polyester of the present invention, which is crosslinked to a gel fraction of 50% or more by the irradiation with ionizing radiation and has a flexural modulus of 100 to 400 MPa and a Young's modulus of 60 to 240 MPa, is not only flexible at ordinary temperature but also favored by heat resistance and strength and therefore, can be suitably used as an externally connecting terminal cap of electronic devices. At the same time, this molded article is biodegradable and is advantageous in that the amount of waste can be reduced in the waste treatment.

The molded article comprising the biodegradable resin of the present invention has heat resistance and strength and therefore, can be suitably used not only as an externally connecting terminal cap of a cellular phone but also as an externally connecting terminal cap or the like provided in various portable electronic devices such as notebook computer, electronic notebook, electronic camera and potable audio device. Furthermore, from the standpoint of reducing the amount of waste at the disposal, this molded article is applicable not only to a portable device but also to a case, a cover and the like of electronic devices.

What is claimed is:

1. An exterior member for electronic devices, comprising:
a biodegradable polyester, and
a polyfunctional monomer mixed in the biodegradable polyester, wherein
the biodegradable polyester has a crosslinked structure with a gel fraction (dry weight of gel portion/initial dry weight) of 50 to 90%,
the flexural modulus is from 100 to 400 MPa, and
the Young's modulus is from 60 to 240 MPa.

2. The exterior member for electronic devices as claimed in claim 1, wherein
the yield strength is 8.5 MPa or more.

3. The exterior member for electronic devices as claimed in claim 1, wherein
a natural-origin or petroleum-origin polymer having a glass transition temperature not more than ordinary temperature is used as the biodegradable polyester.

4. The exterior member for electronic devices as claimed in claim 3, wherein
50 parts by mass or more of one or more members selected from the group including polybutylene adipate terephthalate, polybutylene succinate adipate and polybutylene succinate lactide are contained in 100 parts by mass of the biodegradable polyester.

5. The exterior member for electronic devices as claimed in claim 1, wherein
the polyfunctional monomer comprises an acrylic or methacrylic monomer and the polyfunctional monomer is blended in an amount of 2 to 15 parts by mass per 100 parts by mass of the biodegradable polyester.

6. An electronic device equipped with an externally connecting terminal cap comprising the exterior member as claimed in claim 1.

7. A method for producing the exterior member for electronic devices as claimed in claim 1, comprising the steps of:
blending a polyfunctional monomer in a biodegradable polyester,
kneading the blend,
molding the kneaded material into a predetermined shape,
irradiating the molded article with ionizing radiation at an irradiation dose of 50 to 200 kGy to crosslink the biodegradable polyester to a gel fraction of 50 to 90%.
